(19) United States
(12) Patent Application Publication
(10) Pub. No.: US 2008/0104849 A1
(43) Pub. Date: May 8, 2008

(54) Utility knife with rear gyre pivot structure

(76) Inventor: Kristopher Joseph Mueller, Asheville, NC (US)

Correspondence Address: JACOBSON HOLMAN PLLC, 400 SEVENTH STREET N.W., SUITE 600, WASHINGTON, DC, 20004, US

(21) Appl. No.: 11/593,181

(22) Filed: Nov. 6, 2006

(51) Int. Cl. B26B 3/00; B26B 29/00

(52) U.S. Cl. 30/142; 30/286

(57) ABSTRACT

A heavy duty utility knife structure with rear gyre for balanced stabile cutting using excess force while cutting heavy and thick material. In turn this design becomes safer, easier and is a precision cutting knife to be used in all construction trade including home and hobby as well. With a blade storage and easy hinge opener it is a complete tool.

### BACKGROUND OF THE INVENTION

1. Field of Invention

This invention relates to a hand-held multiple use utility knife structure and specifically a knife with a blade and a wheel assembly. Roofing, Drywall, Flooring and all installers of the construction trade normally use a standard utility knife to cut and Shape material. Since some material is thick and tough, the installer must apply substantial downward pressure on the utility knife to cut through the material. This technique often results in hand injuries. In addition, it is difficult to cut thick and tough material in a straight line using a standard utility knife. Using this knife the user is able to cut thick and heavy duty material. This allows the user cut more consistent strait lines while working with tough and thick material. I feel this knife would help safety and productivity on the job and in the field.

2. Prior Art

U.S. Pat. No. 6,484,404.
U.S. Pat. No. 4,062,116
U.S. Pat. No. 4,197,605
U.S. Pat. No. Re. 32,501
U.S. Pat. No. 4,797,963
U.S. Pat. No. 4,809,437
U.S. Pat. No. 4,974,320
U.S. Pat. No. 5,072,471
U.S. Pat. No. 5,203,852
U.S. Pat. No. 5,355,588
U.S. Pat. No. 5,555,625
U.S. Pat. No. 5,711,077
U.S. Pat. No. 5,725,727
U.S. Pat. No. 7,051,443

### GENERAL SUMMARY DISCUSSION OF INVENTION

Utility knife with proper blade angle matching wheel location inside the knife housing with Pinky finger hub hole, rear wheel assembly is provided. Ergonomic features for multiple hand and finger positions provide for a solid grip in any position. A multi-use utility knife with easy change blade holder and blade storage is provided. In further multi-use embodiments in all applied surfaces in roofing, carpet, dry-wall, cardboard, potentially fabric when using a standard utility blade. With a hook blade used in roofing cutting asphalt shingles can be smoother and safer with a more controlled amount of back pull.

A primary objective of this invention is to provide a knife with an internally mounted wheel that will have enough strength needed for a stabilizer pivot point while rough cutting and precision cutting.

Another objective is to provide an efficient effective tool with multiple features maximizing safety, precision and versatility.

An additional objective is to provide a multi-use tool that could replace tools of less function.

Another objective is to provide a simple design for low cost to consumer and manufacture.

### BRIEF DESCRIPTION OF DRAWINGS

FIG. 1 is a drawing of rear gyre in the present invention

FIG. 2 is showing all internal embodiments

FIG. 3 shows a further embodiment of present invention

### DETAILED DESCRIPTION OF PREFERRED EMBODIMENTS

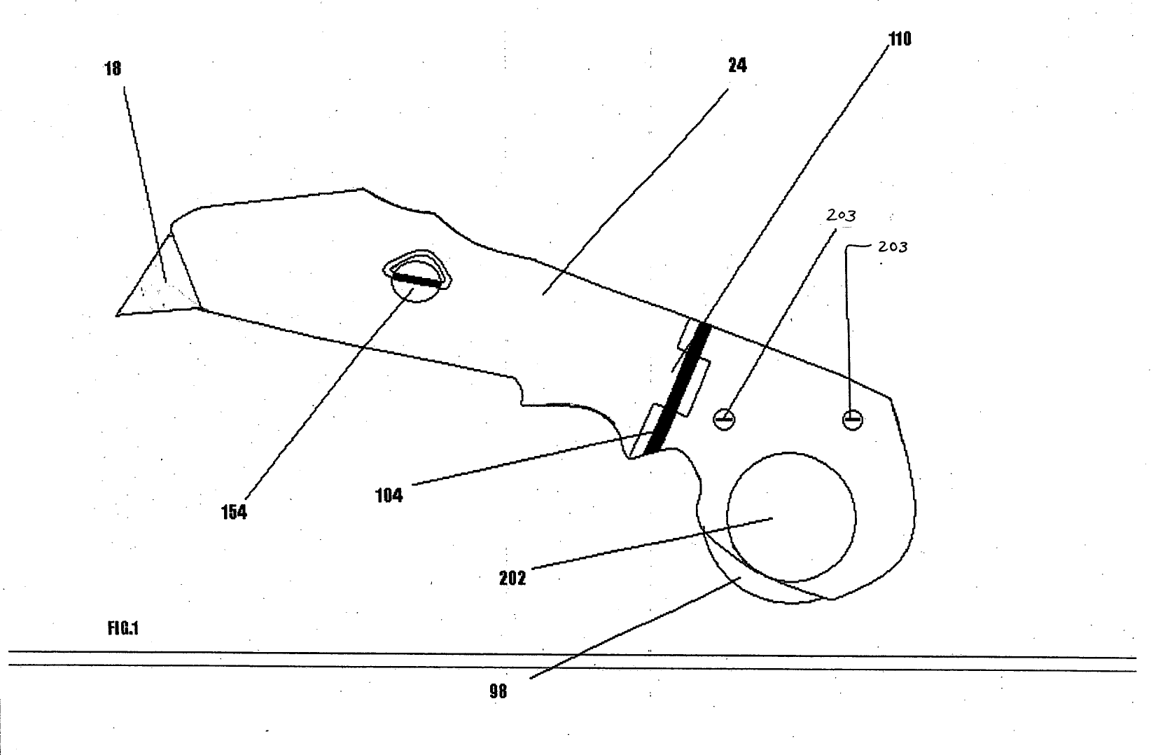

FIG. 1 Shows preferred embodiments of present invention the knife housing 24 and blade 18 combined with the hinge for opening 110 to access and change the blade 18 with hinge pin 104 fastened together by fastening bail screw 154 is separate from the rear portion of the knife which fastened together with screws for rear gyre 202 holding both sides for rear gyre 98 on the opposite end to the blade 18 along with rear gyre 98 there is a rear gyre hole 202 for options of hanging of pulling and pinky to be received.

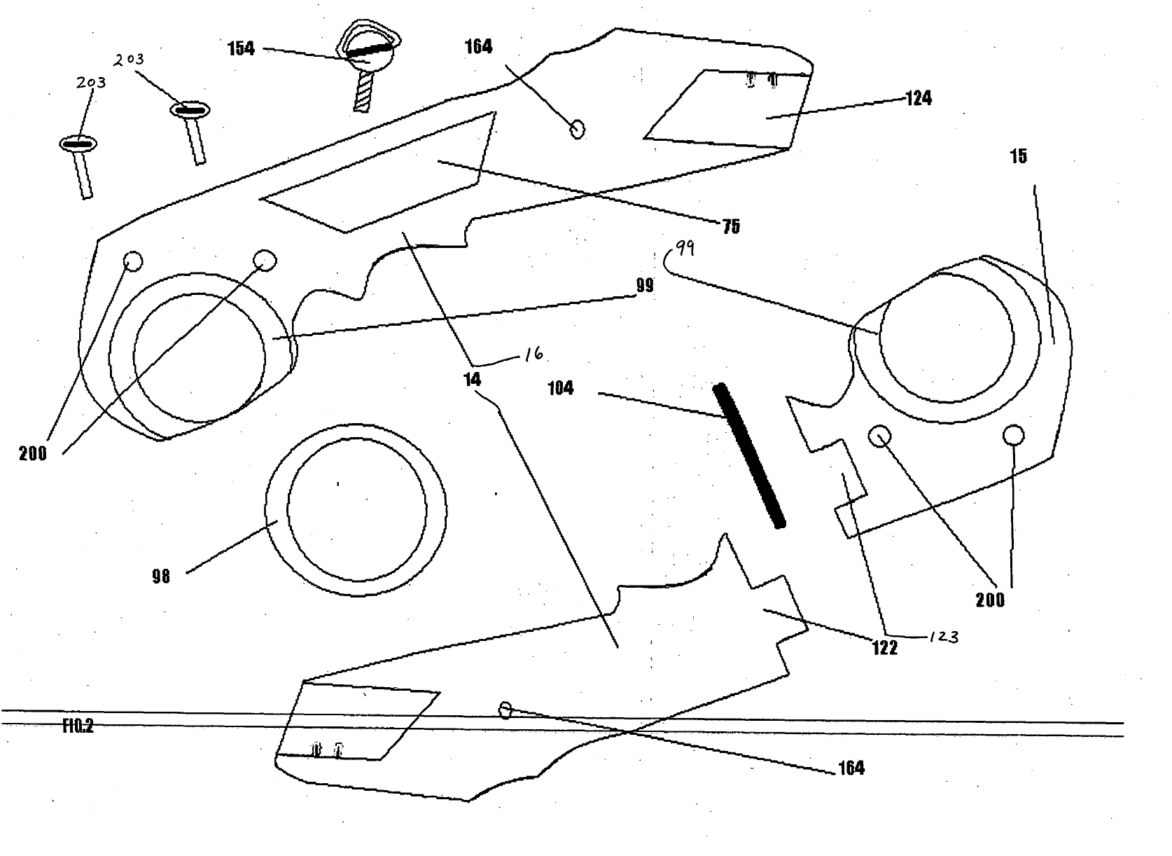

FIG. 2 Shows the internal embodiments of the present invention knife housing Left and Right 14 held together with the fastening bail screw 154 through fastening hole for bail 164. Blade holder 124 and blade storage 75 can be accessed with the bail screw 154 and thus opening knife with the hinge pin 104 hinge sides 122 locking both side together. Rear knife housing 15 fastened together with rear knife housing fastening screws 202 into screw holes for rear gyre assembly 200 to be held in the rear gyre 98 in the rear gyre track 99.

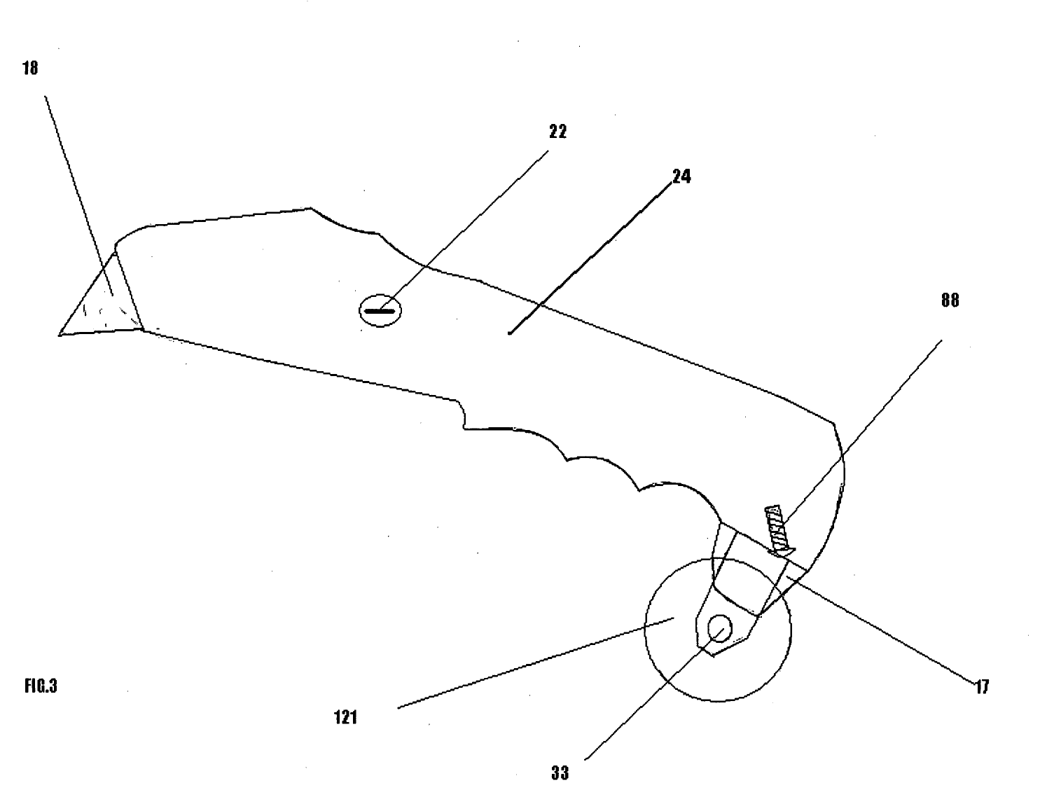

FIG. 3 shows further embodiment with fastening screw 22 holding together knife housing 24 which the rear wheel assembly fastener screw 88 fastens into rear wheel base 17 to fasten the rear wheel 121 and wheel axle 33 to the knife housing 24 opposite the blade 18

### CONCLUSION

The invention enables an installer using the present invention to readily put downward pressure on the knife and then easily cut through tough and heavy material without the fear of hand injury. In addition, the invention enables the many construction trade installers to make a very precise cut when using a lot of pressure.

From the foregoing description of the embodiments of the invention, it will be apparent that many modifications may be made therein. It will be understood, however, that these embodiments of the invention are exemplifications of the invention only and that the invention is not limited thereto.

1. A utility knife comprising:
a housing
said housing having a forward portion, a rear portion, and a middle portion;
a cutting member,
said cutting member being attached to said forward portion,
said middle portion having an area for a handle for user to grip the housing with a hand,
said rear portion containing a gyre of a rear gyre assembly,
a portion of the gyre being located inside the housing and a portion of the gyre being located outside the housing,
said housing having two sides and a mechanism for securing together the two sides,
a storage compartment is in said housing,
a hinge connecting two portions of one of the two sides of the housing with a hinge pin to create access to a blade area, and
a fastener to secure both sides of the housing together with the rear gyre assembly remaining intact while one of the two portions of the one side of the housing is opened.

2. The utility knife as set forth in claim 1, wherein the rear gyre assembly further includes an opening extending through said two sides of the housing.

3. A utility knife comprising
a housing with a forward portion,
a rear portion,
a middle portion having an area used as a hand grip to hold while using the housing,
a forward portion containing a cutting member, and
a rear portion having a solid wheel assembly for stabilizing the knife while cutting.
